(19) United States
(12) Patent Application Publication
(10) Pub. No.: US 2008/0154678 A1
(43) Pub. Date: Jun. 26, 2008

(54) INTERNET BASED SEARCH ENGINE ADVERTISING EXCHANGE

(76) Inventor: Stephen F. Botelho, Dartmouth, MA (US)

Correspondence Address: Stephen F. Botelho Jr., 90 Millers Drive, Dartmouth, MA, 02747, US

(21) Appl. No.: 11/963,655

(22) Filed: Dec. 21, 2007

Related U.S. Application Data
(60) Provisional application No. 60/871,331, filed on Dec. 21, 2006.

(51) Int. Cl. G06Q 10/00

(52) U.S. Cl. 705/7

(57) ABSTRACT

A method and system for transacting the display of advertising on the internet, the method comprising registering a user as a member of a search engine advertising exchange; monitoring a number of search inquiries initiated by the member on the internet within a predetermined time period; and assessing a cost to displaying one or more advertisements desired by the member to be displayed in the internet based on the number of search inquiries initiated by the member.

### CROSS-REFERENCE TO RELATED APPLICATIONS

This application claims the benefit of U.S. Provisional Application No. 60/871,331 filed Dec. 21, 2006.

### BACKGROUND

This invention relates generally to the field of search engine advertising. The invention is related to business models for search engines including those used by companies such as AOL, MySpace, YouTube, FaceBook, and other website based companies. Such companies offer free membership to gain user activity, whereby the website earns its profit by displaying advertisements to its users. Almost all websites which operate with this business model have minimum budget requirements of usually no less than $5000.00. Many businesses such as, car companies, record companies, movie producers, computer companies, and many more spend billions in advertising online each year with websites operating with this business model.

### SUMMARY

In a general aspect of the invention, a method and system for transacting the display of advertising on the internet, the method comprising registering a user as a member of a search engine advertising exchange; monitoring a number of search inquiries initiated by the member on the internet within a predetermined time period; and assessing a cost to displaying one or more advertisements desired by the member to be displayed in the internet based on the number of search inquiries initiated by the member.

Embodiments of this aspect of the invention may include one or more of the following features.

The method further comprises determining a threshold number of search inquiries for which the cost to display one or more advertisements desired by the member is zero. The method further comprises assessing a cost to displaying one or more advertisements desired by the member to be displayed in the internet based on one or more of pay-per-click and number of impressions. The method further comprises establishing a plurality of membership levels, at least one of the levels requiring a lower number of search inquiries to maintain a desired advertisement to be displayed on the internet. The method further comprises rotating a sequence at which a plurality of advertisements from a registered member are being displayed on the internet. The method further comprises determining whether a search inquiry is being conducted by automated software. The method further comprises displaying the one or more advertisements on the internet.

Among other advantages, the invention provides an exciting, new internet based search engine advertising exchange that will change the way ecommerce and search queries are conducted on the internet. Unlike existing advertising platforms, (e.g., eBay, Google, and Yahoo) sellers will have the ability to advertise on a search engine without the need to pay fees. Rather webpages can be advertised based upon a minimum required volume of search queries conducted using the search engine website they are advertising on. A major factor in competition between all online advertising agencies is its average return on investment. The search engine advertising exchange of the invention is advantageous because no monetary investment is necessary. The power of the search engine advertising exchange relies on its members. Every time a member joins and conducts a search query other members gain increased exposure for their advertisements. The primary concept upon which the search engine advertising exchange was developed is, “Make us your favorite search engine and in exchange we will allow you to advertise free of charge.”

The purpose of the present invention is to provide a new internet based service that allows a user to advertise free of charge based on a minimum volume of search queries entered by the user into the main service website. The main service website displays the advertisements of participating members to participating members in conjunction with the search results of a search query done within the main service website.

The present invention can be embodied in computer software, including internet web page based code, and methods of applications for providing the user with an internet based website that offers an advertising exchange between members, whereby participating members conduct search queries within the main service website server, by entering keywords or phrases pertaining to a specific topic. The main service website server then displays member created advertisements in conjunction with the search results. Each member of the main service website must initiate a specific quantity of search queries within the main service website over a given period of time in order to ensure that their specific advertisements continue to be displayed to other members who initiate search queries within the main service website.

A user would visit the main service website and go through the process of registering to become a participating member in the Search Engine Advertising Exchange. Each time that specific user wanted to conduct a search on the internet they would simply sign in to the main service website and enter the keywords or phrases that pertain to the internet content they are seeking. Each search initiated by that specific user as they are signed in to the main service website would be tracked by the main service website and added to the total number of search queries initiated by that user during a specific period of time. The advertisements, of other participating members, which are relevant to the keyword searched by either Meta Tags or by user defined keywords, are displayed with the search engine results. This method of displaying member advertisements to participating members as they initiate internet based content searches, allows user's to display their advertising content to other internet users free of charge.

The search engine advertising exchange disclosed herein may be used in conjunction with different advertisement methods such as; pay per click, impression based marketing, and other forms of internet advertising. The method in which users must maintain a certain volume or quantities of initiated searches could also be modified so that users would earn money or other incentives. The method of searching and or signing in to the search engine advertising exchange may be used differently such as: toolbar search, search bar added to a website, and various other methods of searching.

It is also to be further understood that the internet based search engine advertising exchange offers the user tools and features that will aid them in optimizing their keywords, Meta tags, advertisement content, website description and other aspects of their business or website advertising program. The internet based search engine advertising exchange will also allow a user to view statistics pertaining to their advertisement campaign such as traffic volume per advertisement, duration of time at intended website after linking through from advertisement, total advertisement deliveries, total user clicks, total advertisement impressions, and other standard internet based advertisement related functions and features not referred to herein which are to be considered apparent and obvious to the invention disclosed herein.

The present invention may also offer a multitude of membership levels which directly relate to the amount of search queries that a member would be required to perform over a specific period of time to keep their advertisements displaying with the search results. For example, a free membership may require a user to initiate more search queries to maintain an active status which keeps the users advertisements displaying, whereas a premium membership would have less search query requirements to meet to keep an active status. The search engine advertising exchange requires members to have an active status in order for their advertisements to display with the search results. These two examples of membership levels are only suggestive to illustrate the possible membership types that may be offered by the internet based search engine advertising exchange.

### Signup Process:

The signup process allows the Search Engine Advertising Exchange to identify users, which can be used for many purposes. After receiving login details the user can login and setup their account with advertisements, upgrades, features, etc. Once a user has identified the Search Engine Advertising Exchange can monitor and record the users search queries which is essential in keeping record of and deducting search query requirements.

### Setting Up Advertisements:

The Search Engine Advertising Exchange comprises of a method of creating advertisements, adding keywords that upon query of a search will display the advertisement, as well as adding a URL that will correspond with the advertisement, and allowing for users to compete for keywords. The method involves the user adding a URL and creating an advertisement that are checked by the system for malicious content. The user must also add keywords that will make the advertisement appear when a user conducts a search query using the same or similar keywords. The keywords are checked for availability as not all users will be able to use the same keywords, the more advertisements for a keyword the less exposure each advertisement will receive. If the allotted amount of the keyword for that type of advertisement is full, the user may chose to compete to use the keyword or change to another keyword or advertisement. If the user decides to compete for a keyword, the user's advertisement will be monitored for performance and if it fails to meet qualifications over a certain period of time, the user will have to change keywords.

Other companies such as Google and Yahoo rely on a bidding system in which the more users want a particular keyword the higher the cost of that particular keyword. The new method provided by the Search Engine Advertising Exchange will allow only the best performing advertisements in rotation to be displayed in the search results. This will allow many different businesses from large to small to have a chance at advertising with the most popular keywords. The new method also provides a better search experience for users who will benefit from viewing only the most relevant advertisements.

### How Search Query Requirements are Deducted:

The Search Engine Advertising Exchanges comprises of a new method which assigns users to conduct a certain amount of search queries within a specified period of time (e.g., 50 search queries per month). After signing up each user can be identified by the Search Engine Advertising Exchange, after being identified queries conducted by users are monitored and recorded for the purpose of deducting search query requirements as well as keeping statistics. In order to have a search query requirement deducted the Search Engine Advertising Exchange monitors search queries to ensure each query meets certain quality standards in order to be considered for deduction. Quality standards such as, viewing the search results for a long enough period of time, searching keywords that are unique to the user over a given period of time, staying under a certain amount of searches for a give period of time, are all very important factors in ensuring users are conducting genuine searches. Ensuring users conduct genuine search queries is crucial in order for the advertisements to get proper exposure, as well as keeping the Search Engine Advertising Exchange a legitimate source of advertising.

### How Advertisements are Displayed:

The Search Engine Advertising Exchanges comprises of a new method of displaying, monitoring, and ranking the performance of advertisements displayed within the results of a search query. The method involves displaying advertisements in an orderly rotation according to the keywords and the format of the advertisement the publisher set them to display under. The advertisement can be displayed in a variety of formats upon request of the specified keyword in a search query. The advertisement is rotated in the order it was last displayed advertisements are only displayed if certain criteria are met. The criteria needed for an advertisement to be displayed includes keywords specified match the keywords in the search query, the publisher is an active member, it's the advertisements turn to be displayed, and the advertisement is the correct format for the type of search. The advertisements performance is monitored for various aspects such as, whether or not the user clicked the advertisement to view the publisher's webpage, whether or not the user has clicked the advertisement in the past, how much time the user spent on the publisher's webpage, and whether or not payment or signup links were clicked. After the advertisements performance is monitored the performance is recorded and the advertisements are ranked, advertisements which are lower in rank will be first to be removed when their isn't enough advertising available, based on that keyword and the amount of search queries for the keyword over a given period of time by the amount of publishers using the keyword to advertise. This new method keeps the Search Engine Advertising Exchange showing only the highest performing advertisements which will lead to higher conversion rates as well as better search experience for its users.

### Security Against Malicious Automated Software:

Currently almost all major websites such as Yahoo, Google, PayPal, Blogger, eBay, and Myspace, are using a security measure known as CAPTCHA, which is an acronym for Computer Automated Public Turing test to tell Computers and Humans Apart, to prevent automated software applications from conducting unwanted activities that will damage the website's integrity such as, creating multiple accounts, harvesting emails, sending spam, guessing login details, etc. The CAPTCHA system works by displaying warped words, letters, and symbols, and asking a user to enter what he sees by typing it into normal text in a box and clicking submit to send an answer back to the system. There are many problems with CAPTCHA for starters many who are visually impaired may be able to read the website in normal text but cannot read the warped twisted words, letters and symbols of CAPTCHA. Another problem with using a CAPTCHA security test is that it can be easily defeated by using automated software applications that read the letters. A CAPTCHA security system known as is EZ-GIMPY which was previously used on Yahoo can easily be defeated as the letters are easily identified by software applications made to defeat CAPTCHA security. Over the years CAPTCHA has improved slightly by crowding numbers, letters, and symbols together, making it more difficult for automated software applications to read. Unfortunately however, as much as CAPTCHA security has improved so have the automated applications to read the code.

Although the search engine advertising exchange requires users to conduct a certain quantity of searches over a given period of time, it is important to maintain quality search queries so that users will only conduct searches that our genuine, thereby ensuring advertisements are being displayed to users who are genuinely interested in viewing search results. It would be beneficial to some to use malicious automated software to cheat the system by conducting automated search queries while the user may not even be at his computer. The Search Engine Advertising Exchange has developed a new method of distinguishing a human user from automated software through various types of methods used to conduct search queries. The new method allows for the use of CAPTCHA security however only to a certain threshold, and then it enables the use of security questions and or tests to distinguish a human user from automated software. The new method involves the use of more than one component, for example a user typing search queries on his computers keyboard maybe presented with the question over his computer screen, and called on his cellular phone to give an answer without being given the question, thus making it impossible for automated software that is installed on his computer to answer for him. The new method of engaging a user with security tests and or questions is much more versatile and almost impossible to defeat. The new method is also friendly to those who are visually impaired as once CAPTCHA's allowed threshold has passed, the user will no longer have to read CAPTCHA's scribbled words, letters, and symbols.

Other features and advantages of the invention are apparent from the following description, and from the claims.

### BRIEF DESCRIPTION OF THE DRAWINGS

These and other advantages to the present invention will become more apparent from the following discussion of preferred embodiments of the invention and which are described by way of example only with reference to the accompanying drawings in which like elements have been assigned like numerals wherein:

FIG. 1 is a diagrammatic flow chart showing the process of registering a new member to the system;

FIG. 2 is a diagrammatic flow chart showing the process of a user creating an advertisement and adding it to the system;

FIG. 3 is a diagrammatic flow chart describing the method in which the system determines which advertisements display in response to a search query;

FIG. 4 is a diagrammatic flow chart describing the qualifications a user must meet in order to have search queries requirements deducted;

FIG. 5 is a diagrammatic flow chart describing the automated pruning process whereby the system determines if users have conducted enough search queries (search query requirements) to have their accounts remain active, as well as the process of handling inactive users;

FIG. 6 is a diagrammatic flow chart showing the methods used to review and detect a suspicious search query;

FIG. 7 is a diagrammatic flow chart describing the method used to investigate a suspicious search query and determine it came from an actual user or an automated application;

FIG. 8 is a diagrammatic flow chart describing the process by which the system reviews an advertisements performance in order to assign the advertisement a rating;

FIG. 9 is a diagrammatic flow chart describing the process by which the system calculates the amount of search queries by the amount of advertisements and their performance ratings with certain keywords to determine which advertisements can be allowed to remain active and which advertisements must be suspended;

FIG. 10 is a block diagram showing a brief overview of the Internet Based Search Engine Advertising Exchange.

### DETAILED DESCRIPTION

### 1 Section of the Description

Referring to FIG. 1, a user 101 working through a web browser 103 on a computer 102 accesses the internet 104 and visits the signup page 106 which is hosted on a server 105. Upon accessing the signup page 106, the user fills out identifying information and submits the information 107 to the server 105. The user's information is verified and the S.E.A.E recognizes the user. The system sends the user 101 login details, so the user may login to the S.E.A.E.

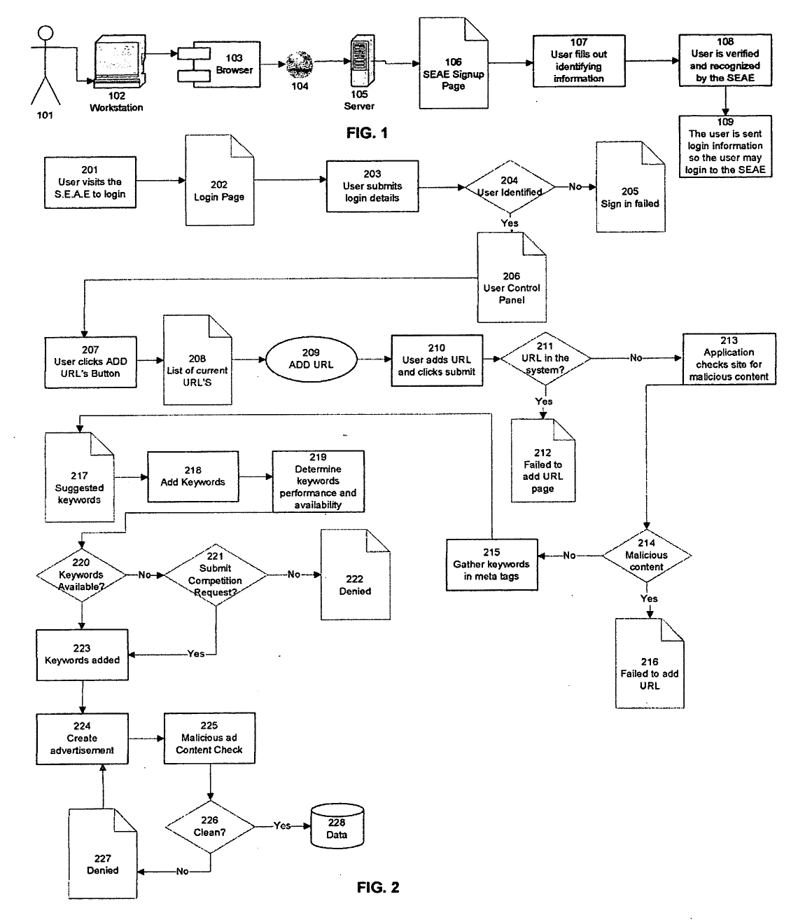

Referring to FIG. 2, a user visits the S.E.A.E. in order to login to the user panel 201. The user visits the login page 202 and submits login details 203. The system makes a determination 204 as to whether the login information is correct based on what is recorded in the system. If the information isn't correct a sign in failed page will appear 205, if the information matches what the system has recorded then the user control panel page is displayed 206. The user has the ability to add websites into the system by clicking the add websites button 207, a list of the users websites already in the system is displayed 208 with an add URL button 209 if the user can add more sites when the button is clicked a page is displayed 210 asking the user to add a URL and click submit, the user enters the information into the application the system checks to see if the url is already in the system and makes a determination 211. If the URL is already in the system a failed to add url page 212 is displayed. If the url is determined to be unique then an application 213 checks the webpage associated with the url for known malicious code (e.g., virus scripts, pop-ups, download links) then a decision 214 is made as to whether the site contains malicious content, if it contains malicious content a failed to add URL page 216 is displayed. If it is determined 215 that the webpage doesn't contain malicious content an application 215 gathers the keywords from the Meta tags which are used to suggest keywords and determine their availability and advertising performance in the system. A suggested keywords page is displayed 217 which shows similar keywords to the keywords gathered from the Meta tags in the users website 215, keywords that have more availability are displayed first. The user can choose to use the suggested keywords or type in his 218. An application is used to determine the keyword(s) performance and availability over various advertisement types 219 and a decision is made as to whether or not the keywords are available 220. If the keywords are not available the user must decide whether or not to submit a competition request 221, if they decide not to they are shown a denied page 222 and must return to the add keywords page 218. If the keywords are available 220 or the user decides to submit a competition request 221, the keywords are added into the system 223. After adding the keywords 223 the user must create an advertisement 224 which is checked using an application for known malicious content 225. A decision is made as to whether the advertisement is clean 226 if the advertisement is not clean then it a denied page displays 227 and the user must create another advertisement 224. If the advertisement is determined clean 226 then it is added into the database 229 and is configured to display in the search results.

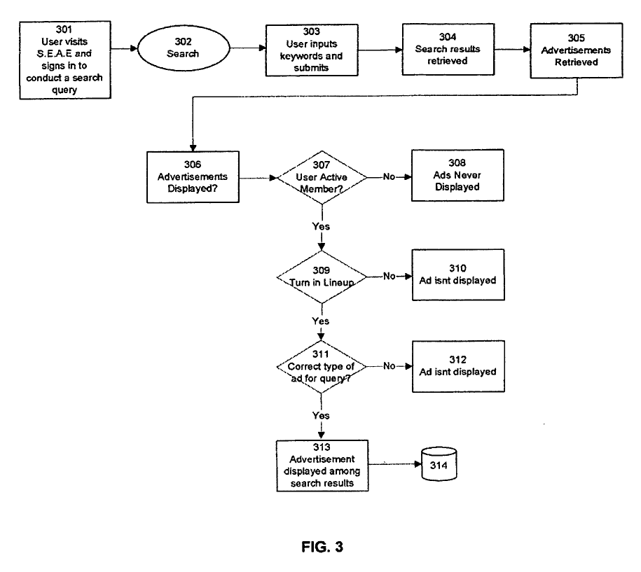

Referring to FIG. 3, a user visits the S.E.A.E. and signs in to conduct a search query. The user clicks the search button 302 inputs keywords and clicks submit 303 the search results are found 304 along with relevant advertisements found by keyword 305 and the advertisement(s) to be displayed are decided upon using an application 306. A decision 307 is made as to whether or not the owner of the relevant advertisement is active. If not the advertisement is never shown 308. If the owner of the advertisement is active then a decision is made as to whether or not if it's the advertisements turn in the lineup 309. If not then the advertisement isn't displayed 3 10. If it is the advertisements turn in the lineup than a decision is made to determine if it's the proper type of advertisement for the search 311. If not the advertisement isn't displayed 312. If it is the correct format for the search then using an application the advertisement is displayed with the search results 313. All the activity is recorded in a database 314.

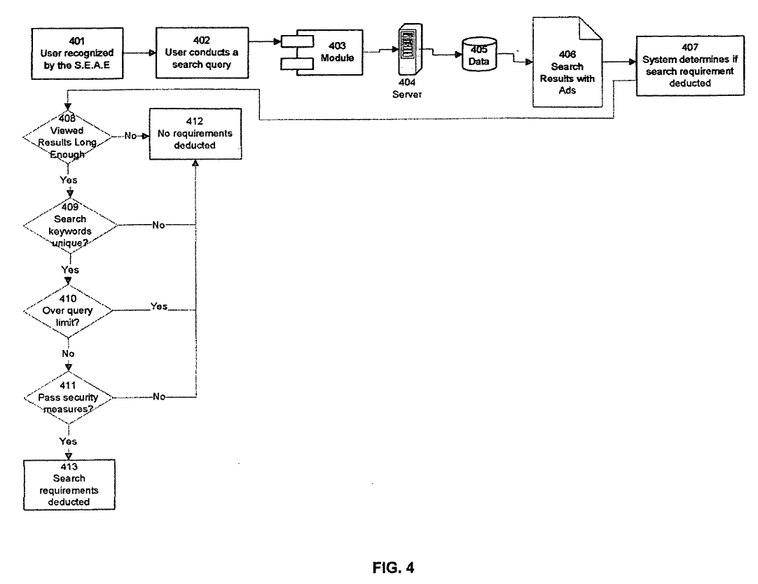

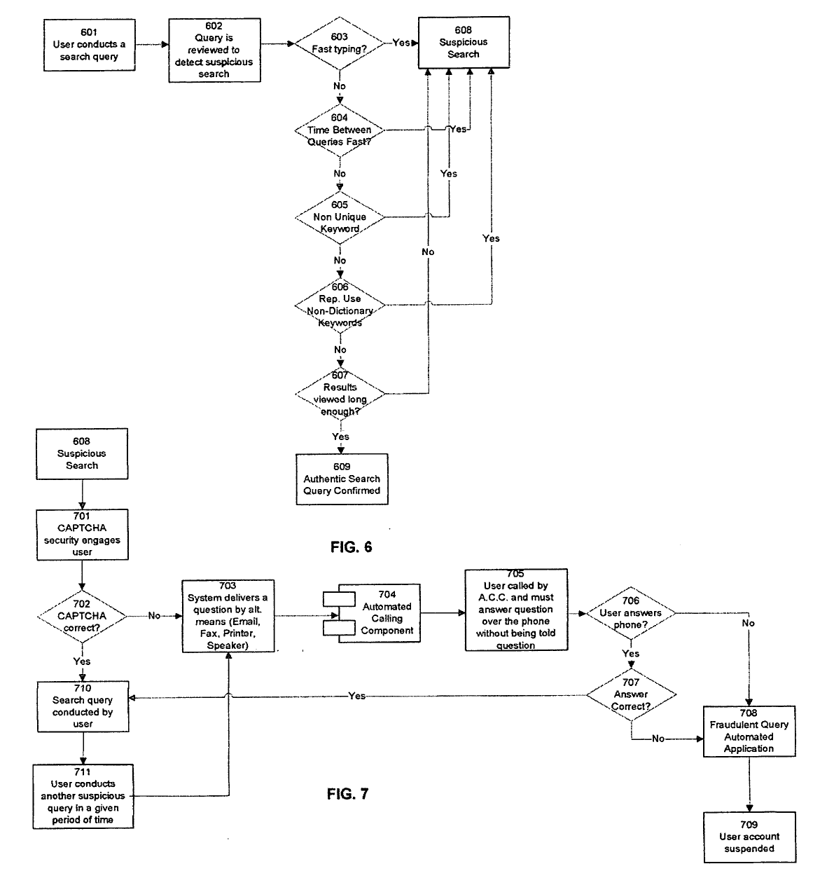

Referring to FIG. 4, a user has been recognized by the S.E.A.E. 401. The user conducts a search query 402 in which a module accesses a database 401 through a server and displays the results along with advertisements 405. The system reviews the query 402 to determine if the search query is eligible to be deducted from the search query requirements 407, which are based upon a minimum amount of search queries conducted over a given period of time that is determined by the administration. The system determines if the search results 406 were viewed for a sufficient period of time 408, (the administration determines a sufficient period of time and configures the system accordingly). If the search results 406 were viewed for a sufficient period of time 408, the system then determines 409 if the query 402 was conducted using unique keywords for that user over a given period of time, the actual amount of time before a keyword is considered unique again is configured in the system by the administration. If the query 402 was conducted using unique keywords 409, the system then determines if the user has conducted too many search queries in a given period of time, based upon set values configured in the system by the administration. If the user is within his search query limit 410, the system then determines 411 if the user passed security measures, as described in FIG. 6. If the user passed security measures 411, search query requirements are deducted 413. If the user didn't view the search results 406 for a sufficient period of time, or the query 402 didn't use unique keywords, or the user was over the search query limit 410, or the user failed to pass security measures 411, then no search query requirements are deducted 412.

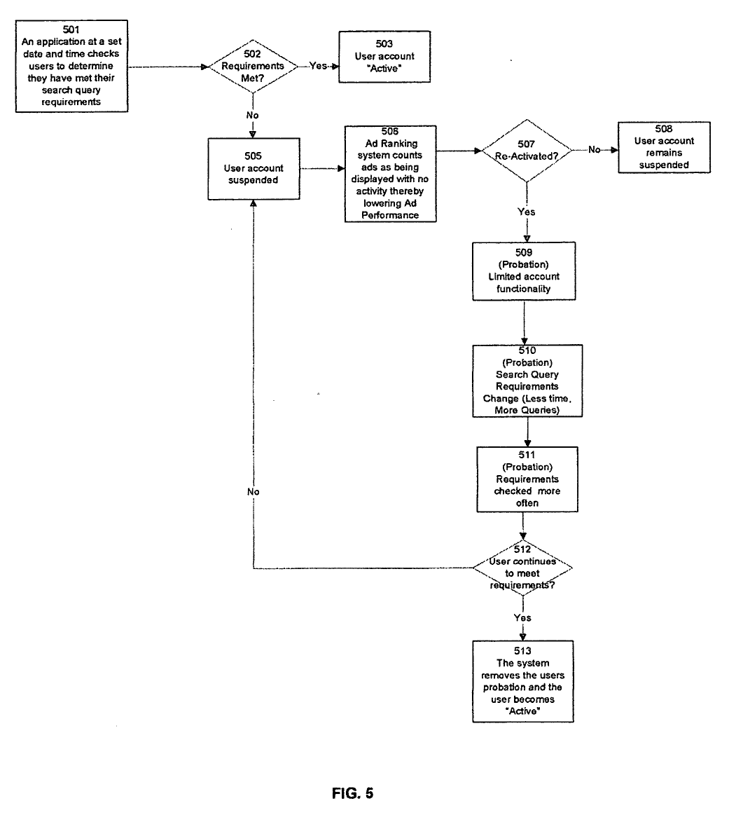

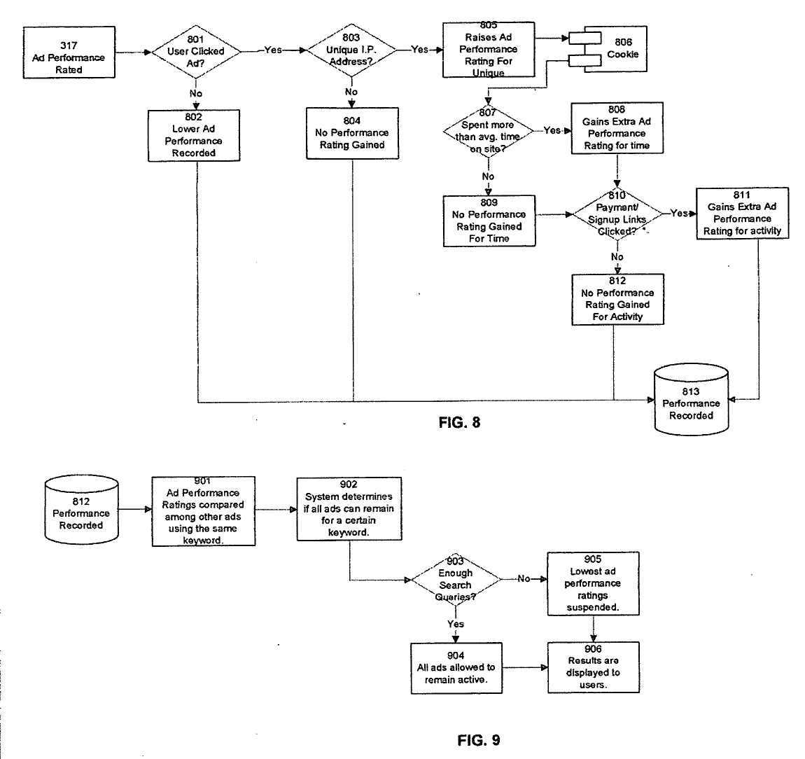

Referring to FIG. 5, an application at a set date and time checks the system to determine if all the users of the S.E.A.E. have met their search query requirements, as described in FIG. 4. The system determines if a user has met the search query requirements 502. If the user has met the search query requirements 502 the user's account remains active 503. If the user failed to meet the search query requirements 502, the users account becomes suspended 504. After the user becomes suspended 504 the user's advertisements stop displaying in the search results as demonstrated in FIG. 3, however the performance rating as seen in FIG. 8 counts the advertisements as being displayed with no activity thereby lowering the suspend advertisements performance rating 505. The suspended user may decide to reactivate their account by paying a fine or making up search query requirements 506. If the account isn't reactivated 506 the user remains suspended 507. If the account is reactivated 506 the user's account status is set to probation in which the user will have limited account functionality 508. Accounts that have a probationary status have different search query requirements than accounts that have an active status, accounts that have a probationary status are required to conduct more search queries in a shorter period of time 509. Because accounts with a probationary status have different search query requirements than active accounts 509, the system checks 510 more often to determine if they have met their requirements 502. After a given period of time e.g., 3 months, the system determines if the user has improved their record of meeting the search query requirements 511. If so the system removes the user's probation status and the user becomes recognized as an active user again with full account functionality 512. If not the user's account will remain suspended 507.

Referring to FIG. 6, A user conducts a search query 601 which is reviewed and compared with prior search queries by the system 602 to detect suspicious search queries which may have been conducted carelessly or by an automated query application. The system reviews how fast the user typed in the keywords of the search query 601 and makes a decision as to whether or not the user typed too fast 603. If the user didn't type in the keywords too fast 603, the system decides if the time between the search query 601 and the query before it was too fast 604. If the time between the current search query 601 and the one before it was not too fast 604, the system determines if the user has already searched using the keyword used to conduct the search query 601 within a given period of time 605. If not keyword is unique 605, the system then determines 606 if the user used a non-dictionary or unknown word to conduct the search query 601 as well as prior search queries within a given period of time. If the user did not conduct repeated search queries with non-dictionary words 606, the system determines if the user viewed the search results for a long enough period of time 607. If the user viewed the results for a long enough period of time 607 the search query is confirmed authentic 609. If the user typed the search keywords too fast 603, or the time in between the current search query 601 and the one before it was too short, or the user had already queried the same keywords in another search query within a given period of time, or the user used non dictionary/known keywords 606, or the search results were not viewed for a long enough period of time 607, the search query 601 is identified as a suspicious search 608.

Referring to FIG. 7, after detecting a suspicious search query 608 which can be seen in FIG. 6, a security application known as CAPTCHA engages the user to enter the correct letters and or numbers seen in an image 701. The system then determines if the user entered the correct CAPTCHA code 702. If the user failed to enter the correct CAPTCHA code 702, the system delivers a question by alternative means based on the users set preferences 703. Using an automated calling component 704 the user is called on the phone number used to sign up, and must answer the question without the question being repeated over the phone 705. The system determines if the user answered the phone 706. If the user answered the phone 706, the system determines 707 if the user answered the question 703 correctly. If the user didn't answer the phone 706 or the response was incorrect 707, the search is confirmed fraudulent 708. The users account gets suspended 709. If the user entered the correct CAPTCHA 702, or answered the question correctly 707 the search query is verified as authentic 710. If the user conducts another suspicious search query within a given period of time 711, the user is not engaged by CAPTCHA 701, instead is given an alternative question 703.

Referring to FIG. 8, the advertisement performance is rated 317 after a user conducts a search query as seen in FIG. 3. A decision is made 801 as to whether or not the query resulted in the advertisement being clicked; if not then a lower advertisement performance rating is recorded 802. If the advertisement is clicked 801, the system decides if the user has already clicked the ad recently by determining if they have a unique internet protocol address 803. If the user doesn't have a unique internet protocol address 803 for clicking the advertisement then no advertisement performance is gained or lost 804. If the internet protocol address that clicked the advertisement is unique 803 the advertisement performance rating for unique is increased 805. If the user that clicked the advertisement had a unique internet protocol address 803, the system then determines 806 if the user spent more than an average amount of time on the website the advertisement directed the user to, based on information gathered from a tracking cookie 806 installed in the user's browser when the advertisement was clicked. If the user didn't spend more than the average time on the website the advertisement directed the user to 807, the advertisement doesn't increase its ad performance rating for time 809. If the user spent more than the average time on the website the advertisement directed the user to 807, the advertisement increases its ad performance rating for time 808. After the system determines whether or not the advertisements performance rating was increased 808 or not 809, the system then determines if the user clicked on any known payment or signup links 810. If the user clicked on any payment or signup links 810 the advertisements performance rating is increased 811. If the user didn't click on any payment or signup links 809 the advertisements performance rating isn't increased 812. A lower ad performance rating 802, or no ad performance rating gained 804, or no performance rating gained for time 809 and or activity 812, or an increased ad performance rating for unique 805 and or time 808 and or activity 812, is recorded in a database 813.

Referring to FIG. 9, advertisement performance ratings which are recorded in a database 813 as seen in FIG. 8, are compared among advertisements using the same keywords 901. The system calculates if all ads can remain for a particular keyword 902. The system determines 903 if there are enough search queries over a period of time for the particular keyword to accommodate all advertisements which use that keyword. If there is enough search queries to accommodate all advertisements for a particular keyword 903, all advertisements using the particular keyword are allowed to remain active 904. If there isn't enough search queries to accommodate all advertisements for a particular keyword 903, advertisements which have the lowest ad performance rating are suspended until the amount of search queries accommodates the amount of advertisements 905. The advertisement performance ratings which include individual results, as well as the average performance rating, and the least acceptable performance rating for particular keywords are displayed to all the users 906.

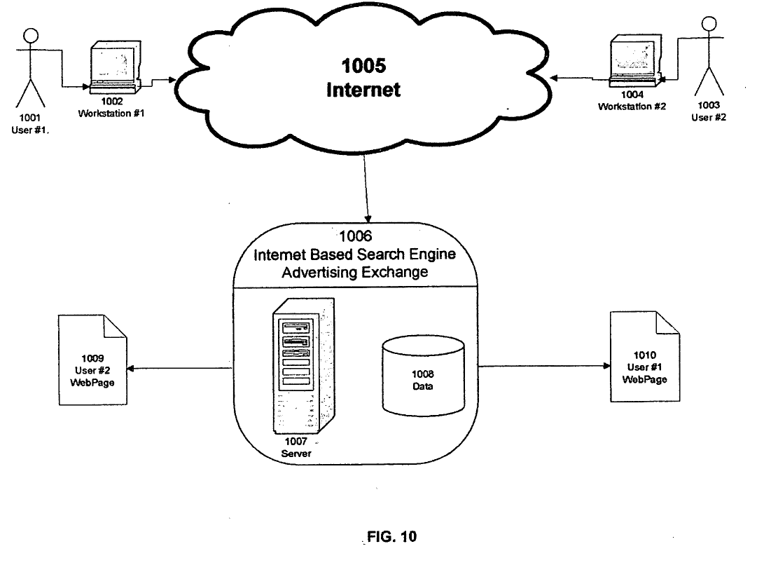

Referring to FIG. 10, user's 1001, and 1003 use workstations 1002, and 1004 to access the internet 1005. Upon accessing the internet 1005 they visit the Internet Based Search Engine Advertising Exchange 1006 and conduct a search query which searches a database 1008 which is located on the Internet Based Search Engine Advertising Exchange main server 1007 to display search results. Upon viewing the search results user 1001 views user 1003 advertisement and user 1003 visits user 1001 advertisement. They click the advertisement and are displayed each others webpage's 1009 and 1010.

It is to be understood that the foregoing description is intended to illustrate and not to limit the scope of the invention, which is defined by the scope of the appended claims. Other embodiments are within the scope of the following claims.

What is claimed is:

1. A method for transacting the display of advertising on the internet, the method comprising:
registering a user as a member of a search engine advertising exchange;
monitoring a number of search inquiries initiated by the member on the internet within a predetermined time period; and
assessing a cost to displaying one or more advertisements desired by the member to be displayed in the internet based on the number of search inquiries initiated by the member.

2. The method of claim 1 further comprising determining a threshold number of search inquiries for which the cost to display one or more advertisements desired by the member is zero.

3. The method of claim 1 further comprising assessing a cost to displaying one or more advertisements desired by the member to be displayed in the internet based on one or more of pay-per-click and number of impressions.

4. The method of claim 1 further comprising establishing a plurality of membership levels, at least one of the levels requiring a lower number of search inquiries to maintain a desired advertisement to be displayed on the internet.

5. The method of claim 1 further comprising rotating a sequence at which a plurality of advertisements from a registered member are being displayed on the internet.

6. The method of claim 1 further comprising determining whether a search inquiry is being conducted by automated software.

7. The method of claim 1 further comprising displaying the one or more advertisements on the internet.

8. A search engine advertising exchange system for transacting the display of advertising on the internet, the system comprising:
a registration module configured to register a user as a member of a search engine advertising exchange;
a monitor module for tracking a number of search inquiries initiated by the member on the internet within a predetermined time period; and
a cost module for assessing a cost to displaying one or more advertisements desired by the member to be displayed in the internet based on the number of search inquiries initiated by the member.

9. The system of claim 8 further comprising a display module for displaying the one or more advertisements on the internet.

10. The system of claim 8 wherein the monitor module determines a threshold number of search inquiries for which the cost to display one or more advertisements desired by the member is zero.

11. The system of claim 8 wherein the cost module assesses a cost to displaying one or more advertisements desired by the member to be displayed in the internet based on one or more of pay-per-click and number of impressions.

12. The system of claim 8 wherein the registration module establishes a plurality of membership levels for registration, at least one of the levels requiring a lower number of search inquiries to maintain a desired advertisement to be displayed on the internet.

13. The system of claim 9 wherein the display module rotates a sequence at which a plurality of advertisements from a registered member are being displayed on the internet.

14. The system of claim 8 further comprising an authentication module for determining whether a search inquiry is being conducted by automated software.
